(19) United States
(12) Patent Application Publication
(10) Pub. No.: US 2022/0214928 A1
(43) Pub. Date: Jul. 7, 2022

(54) Workload Configuration Extractor

(71) Applicant: Virsec Systems, Inc., San Jose, CA (US)

(72) Inventors: Satya V. Gupta, Dublin, CA (US); Subhash C. Varshney, Burlington, MA (US); Piyush Gupta, Jabalpur (IN); Vishal Dixit, Bangalore (IN); Avishek Nag, Kolkata (IN); Rohan Ahuja, Gurugram (IN)

(21) Appl. No.: 17/578,379

(22) Filed: Jan. 18, 2022

Related U.S. Application Data
(63) Continuation-in-part of application No. 17/460,004, filed on Aug. 27, 2021.
Application No. 17/460,004 is a continuation-in-part of application No. 17/646,622, filed on Dec. 30, 2021.
Application No. 17/646,622 is a continuation-in-part of application No. PCT/US2021/048077, filed on Aug. 27, 2021.
Application No. PCT/US2021/048077 is a continuation-in-part of application No. PCT/US2021/073201, filed on Dec. 30, 2021.
(60) Provisional application No. 63/071,113, filed on Aug. 27, 2020.
(60) Provisional application No. 63/133,173, filed on Dec. 31, 2020.
(60) Provisional application No. 63/155,466, filed on Mar. 2, 2021.
(60) Provisional application No. 63/155,464, filed on Mar. 2, 2021.
(60) Provisional application No. 63/190,099, filed on May 18, 2021.
(60) Provisional application No. 63/132,894, filed on Dec. 31, 2020.
(60) Provisional application No. 63/155,466, filed on Mar. 2, 2021.
(60) Provisional application No. 63/071,113, filed on Aug. 27, 2020.
(60) Provisional application No. 63/133,173, filed on Dec. 31, 2020.
(60) Provisional application No. 63/155,466, filed on Mar. 2, 2021.
(60) Provisional application No. 63/155,464, filed on Mar. 2, 2021.
(60) Provisional application No. 63/190,099, filed on May 18, 2021.
(60) Provisional application No. 63/132,894, filed on Dec. 31, 2020.
(60) Provisional application No. 63/155,466, filed on Mar. 2, 2021.
(60) Provisional application No. 63/155,466, filed on Mar. 2, 2021.

(30) Foreign Application Priority Data
Jan. 18, 2021 (IN) 202141002208

(51) Int. Cl. G06F 9/50; G06N 20/00

(52) U.S. Cl. CPC G06F 9/5083; G06F 9/5033; G06N 20/00; G06F 9/5077; G06F 9/5044

(57) ABSTRACT

Embodiments determine configuration information pertaining to a compute layer, a virtualization layer, and a service layer of a computing workload. In an example embodiment, a machine learning engine interfaces with a workload deployed upon a network to initially determine file structures of the workload. The machine learning engine then compares the determined file structures of the workload with predefined representations of file structures stored in a classification database. In turn, the machine learning engine identifies configuration information pertaining to the workload based on the comparing.

### RELATED APPLICATIONS

This application is a continuation-in-part of and claims priority to U.S. application Ser. No. 17/460,004, filed on Aug. 27, 2021, which claims the benefit of U.S. Provisional Application No. 63/071,113, filed on Aug. 27, 2020; U.S. Provisional Application No. 63/133,173, filed on Dec. 31, 2020; U.S. Provisional Application No. 63/155,466, filed on Mar. 2, 2021; U.S. Provisional Application No. 63/155,464, filed on Mar. 2, 2021; and U.S. Provisional Application No. 63/190,099, filed on May 18, 2021 and claims priority under 35 U.S.C. § 119 or 365 to India Provisional Application No. 202141002208, filed on Jan. 18, 2021 and India Provisional Patent Application No. 202141002185, filed on Jan. 18, 2021.

This application is a continuation-in-part of and claims priority to U.S. application Ser. No. 17/646,622, filed Dec. 30, 2021, which claims the benefit of U.S. Provisional Application No. 63/132,894, filed on Dec. 31, 2020, and U.S. Provisional Application No. 63/155,466, filed on Mar. 2, 2021 and claims priority under 35 U.S.C. § 119 or 365 to India Provisional Application No. 202141002208, filed on Jan. 18, 2021.

This application is a continuation-in-part of International Application No. PCT/US2021/048077, which designated the United States and was filed on Aug. 27, 2021, published in English, which claims the benefit of U.S. Provisional Application No. 63/071,113, filed on Aug. 27, 2020; U.S. Provisional Application No. 63/133,173, filed on Dec. 31, 2020; U.S. Provisional Application No. 63/155,466, filed on Mar. 2, 2021; U.S. Provisional Application No. 63/155,464, filed on Mar. 2, 2021; and U.S. Provisional Application No. 63/190,099, filed on May 18, 2021 and claims priority under 35 U.S.C. § 119 or 365 to Indian Provisional Application No. 202141002208, filed on Jan. 18, 2021 and Indian Provisional Patent Application No. 202141002185, filed on Jan. 18, 2021.

This application is a continuation-in-part of International Application No. PCT/US2021/073201, which designated the United States and was filed on Dec. 30, 2021, published in English, which claims the benefit of U.S. Provisional Application No. 63/132,894, filed on Dec. 31, 2020, and U.S. Provisional Application No. 63/155,466, filed on Mar. 2, 2021 and claims priority under 35 U.S.C. § 119 or 365 to Indian Provisional Application No. 202141002208, filed on Jan. 18, 2021.

This application claims the benefit of U.S. Provisional Application No. 63/155,466, filed on Mar. 2, 2021.

The application claims priority under 35 U.S.C. § 119 or 365 to India Application No. 202141002208, filed Jan. 18, 2021.

The entire teachings of the above applications are incorporated herein by reference.

### BACKGROUND

Workloads are known to utilize various computing resources to accomplish tasks as desired by a user entity by loading and executing appropriate software instructions. Such workloads may be deployed across a network of an organization such as an enterprise, and may feature, for example, various versions of sets of software instructions.

### SUMMARY

Embodiments provide a method for automatically determining configuration information pertaining to a computing workload.

In some embodiments, a machine learning engine interfaces with a workload deployed upon a network to determine file structures of the workload. The machine learning engine compares the determined file structures of the workload with predefined representations of file structures stored in a classification database. The classification database may be a framework discovery database. In turn, the machine learning engine evaluates whether a given predefined representation substantially matches the file structures of the workload according to an accuracy threshold. If the result of the evaluation is “no,” the machine learning engine returns to determining file structures, so as to continue monitoring the workload for changes that may introduce a file structure that may substantially match the file structure of the workload. If the result of the evaluation is “yes,” the machine learning engine identifies configuration information pertaining to the workload based on the comparing. After such an identification, the method returns to determining configuration information for continuous monitoring as described above.

In some embodiments, the workload includes at least one of a framework, an operating system, and a software application. In some embodiments, the workload includes hardware. In such embodiments, the hardware includes one or more processors, one or more memory devices, one or more storage devices, and one or more network adapters. In such embodiments, the method further includes determining a status of a resource pertaining to the hardware tool by taking a pre-defined number of measurement samples at a node of the hardware tool, and comparing a function of the measurement samples with a pre-defined threshold value.

In some embodiments, the configuration information is at least one of an identifier of a framework or library associated with the workload, and at least one of a language, a version, and a name of a framework, operating system, or application deployed upon the workload. An identifier of a library may be, for example, a name of a library file such as a .dll file. In some embodiments, the configuration information includes type details of a virtualization environment deployed upon the workload, wherein the type details include at least one of a designation as serverless, a designation as a container, and a designation as a virtual machine. In some embodiments, the method further includes configuring the machine learning engine to modify representations of file structures stored within the classification database, or store additional representations of file structures within the classification database according to an update of a framework, operating system, or application, or creation of a new framework, operating system, or application.

In some embodiments, the identifying is informed by the evaluation of the result of the comparing, wherein the evaluation includes evaluating the result of the comparing with the aforementioned accuracy threshold. Some embodiments further include automatically determining a protection action based on the identified configuration information, and issuing an indication of a recommendation of the determined protection action to a controller associated with the workload. Some such embodiments further include automatically selecting the recommendation from a recommendation database. In some embodiments, the recommendation is selected from the recommendation database by an end-user. In some embodiments, the method further includes, prior to issuing the indication of the recommendation, augmenting a recommendation database in response to an input from an end-user defining the recommendation.

Some embodiments further include deploying software instrumentation upon the workload. The software instrumentation can be configured to determine real-time performance characteristics of the workload. In some such embodiments, the software instrumentation is further configured to indicate a condition of overload perceived at the workload. In some embodiments, the identified configuration information includes an indication of a vulnerability associated with the workload. In some such embodiments, the vulnerability is identified based on an examination of process memory. In such embodiments, the indication of the vulnerability further provides a quantification of security risk computed based on the examination of process memory. In some embodiments, the identified configuration information includes an indication of at least one file that is to be touched by a given process during a lifetime of the given process running upon the workload. In such embodiments, the method includes constraining execution of the given process to prevent the given process from loading files other than the at least one file that is to be touched by the given process, thereby increasing trust in the given process. In some embodiments, the workload includes a plurality of workloads. In some embodiments, a framework, an operating system, or an application is distributed or duplicated amongst the plurality of workloads. In some embodiments, the method further includes constructing a topological representation of the plurality of workloads based on identified configuration information corresponding to respective workloads of the plurality thereof.

Another example embodiment is directed to a system for automatically determining configuration information pertaining to a computing workload. In such an embodiment, the system includes a machine learning engine configured to determine file structures of the workload. The machine learning engine is further configured to compare the determined file structures of the workload with predefined representations of file structures stored in a classification database. The classification database may be a framework discovery database. The machine learning engine is configured to evaluate whether a given predefined representation substantially matches the file structures of the workload. If the result of the evaluation is “no,” the machine learning engine returns to determining file structures, so as to continue monitoring the workload for changes that may introduce a file structure that may substantially match the file structure of the workload. If the result of the evaluation is “yes,” the machine learning engine identifies configuration information pertaining to the workload based on the comparing. After such an identification, the machine learning engine returns to determining configuration information for continuous monitoring as described above.

Yet another example embodiment is directed to a computer program product for automatically determining configuration information pertaining to a computing workload. In such an embodiment, the computer program product includes one or more non-transitory computer-readable storage devices and program instructions stored on at least one of the one or more storage devices. In such an embodiment, the program instructions, when loaded and executed by a processor, cause a machine learning engine associated with the processor to determine file structures of the workload. The machine learning engine is further configured to compare the determined file structures of the workload with predefined representations of file structures stored in a classification database. The classification database may be a framework discovery database. The machine learning engine is configured to evaluate whether a given predefined representation substantially matches the file structures of the workload. If the result of the evaluation is “no,” the machine learning engine returns to determining file structures, so as to continue monitoring the workload for changes that may introduce a file structure that may substantially match the file structure of the workload. If the result of the evaluation is “yes,” the machine learning engine identifies configuration information pertaining to the workload based on the comparing. After such an identification, the machine learning engine returns to determining configuration information for continuous monitoring as described above.

It is noted that embodiments of the method, system, and computer program product may be configured to implement any embodiments described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a schematic block diagram showing a full stack representation of an example software application subject to an embodiment.

FIG. 2 is a block diagram showing an example workload subject to an embodiment.

FIG. 3 is a flow chart of an example method of automatically determining configuration information pertaining to a workload according to an embodiment.

FIG. 4A is a schematic block diagram showing an example system for automatically determining configuration information pertaining to a workload, according to an embodiment.

FIG. 4B is a block diagram showing an architecture of an example model based on configuration information determined according to an embodiment.

FIGS. 5A-E are flow diagrams showing various example embodiments of a method for automatically determining configuration information pertaining to a workload.

FIG. 6 is a diagram showing various application maps used by system monitors for controlling embodiments.

FIG. 7 is a block diagram showing automatic configuration manager (ACM) infrastructure architecture according to an embodiment.

FIGS. 8A-B are flow diagrams showing example workflows for discovery of interpreted and binary frameworks respectively, according to embodiments.

FIG. 9 illustrates a computer network or similar digital processing environment in which embodiments may be implemented.

FIG. 10 is a diagram illustrating an example internal structure of a computer in the environment of FIG. 9.

### DETAILED DESCRIPTION

A description of example embodiments follows.

Embodiments provide a method of determining configuration information pertaining to a workload. In some embodiments, the workload is deployed upon a network. Amongst other examples, workloads may include frameworks, operating systems, or applications, or a combination thereof.

Some embodiments use machine learning to automatically determine configuration information pertaining to the workload. Some such embodiments implement an Application Topology Extraction Machine Learning (ATE-ML) engine to automatically determine configuration information for workloads. In such embodiments, an ATE-ML engine may be configured to produce an output that can, in turn, be used to create, for example, an application-aware inventory of software assets deployed on the network as represented in an application topology file, as described in U.S. application Ser. No. 17/646,622, filed Dec. 30, 2021. The ATE-ML engine may alternatively or additionally be configured to produce, as outputs, other representations of configuration information pertaining to at least one workload.

Embodiments of an ATE-ML engine are configured to perform auto-discovery and auto-compliance procedures as described hereinbelow, and to establish auto-instrumentation of a subject network and workloads associated therewith.

Embodiments of an ATE-ML engine perform a deep discovery and learning of a network environment, e.g., of an organization such as an enterprise. In such embodiments, the performing of the deep discovery and learning serves to inform establishment of the aforementioned auto-discovery, auto-compliance, and auto-instrumentation procedures.

Example Environment of Implementation

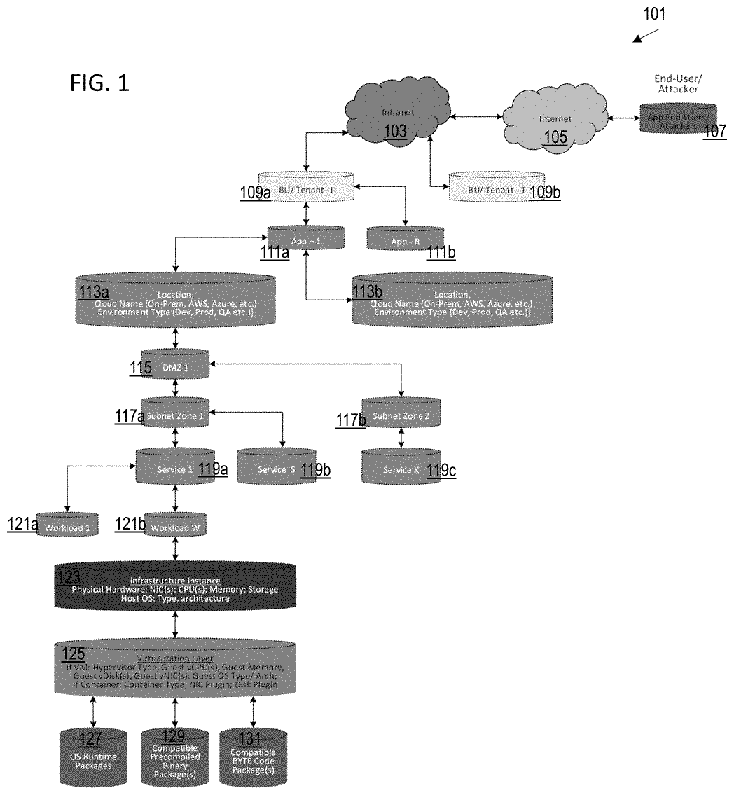

FIG. 1 is a schematic block diagram depicting an example network environment 101 in which an embodiment of a method of automatically determining configuration information may be performed. In such an embodiment, a workload may include a monolith or microservices-based software application. Such an application may be installed at additional workloads deployed across a network. In FIG. 1, objects 111a, 111b, 113a, 113b, 115, 117a, 117b, 119a, 119b, 119c, 121a, 121b represent network topology of an aspect of a workload such as an application. Depicted in the lowest layer of the network topology are individual workloads that provide the application functionality. Such individual workloads may comprise three layers, including an infrastructure layer (shown in red in FIG. 1), a virtualization layer (shown in orange in FIG. 1) and a service layer (shown in blue in FIG. 1). In such an embodiment, code used within a given workload can be resident in either the file system or in memory. The network environment 101 may include an intranet 103 connected to the Internet 105 and as such may be accessed by an end-user 107. In some cases, the end-user 107 may be a malicious attacker.

Continuing with respect to FIG. 1, deployed upon the intranet 103 is business logic for respective business units, which may include a first business unit 109a and other business units up to and including a Tth business unit 109b. Such business units may also be referred to as tenants. Within the business logic for the business units 109a, 109b are software applications 111a, 111b. While only a first application 111a and second application 111b are depicted, the business units 109a and 109b may utilize any number of applications. Each such application 111a, 111b is deployed on at least one cloud location 113a, 113b. Within the cloud location 113a, 113b is deployed a demilitarized zone 115, beyond which are deployed at least one subnet from a first subnet zone 117a to a Zth subnet zone 117b. Within the subnet 111a, 117b are deployed various services including at least a first service referred to as service 119a and a last service referred to as service 119b on subnet zone 117a. Other subnets may also run services, depicted in the diagram 101 as subnet zone Z 117b running service K 119c. Within each service, such as service 119a, are deployed workflows including at least a first workload 121a up to and including a Wth workload 121b. Upon each workload is deployed an application service instance. The application service instance includes an infrastructure hardware layer 123, a virtualization layer 125, and a service, which may include operating system runtime packages 127, compatible precompiled binary packages 129, and compatible byte code packages 131.

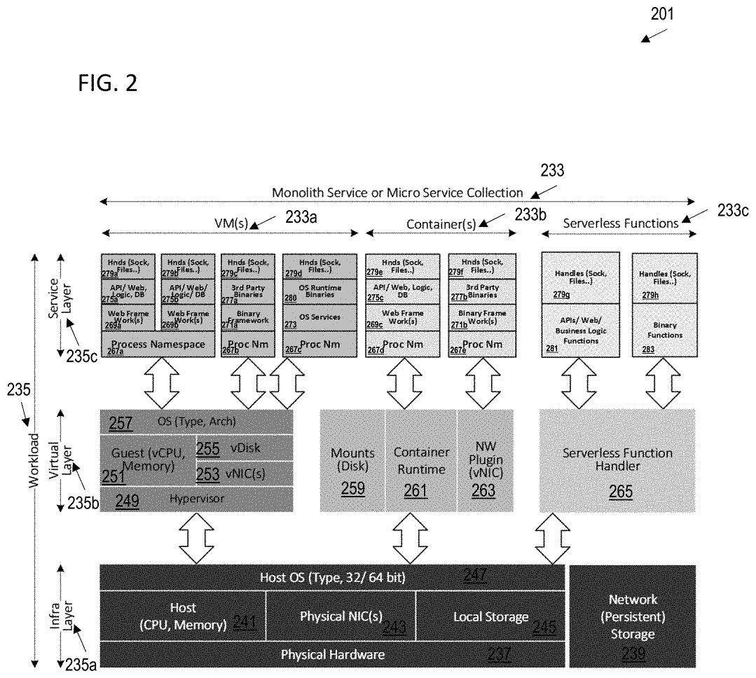

FIG. 2 is a block diagram 201 illustrating an individual workload that may be deployed upon a network to enable functionality of software such as an application. Such a workload may include an infrastructure layer, a virtualization layer, and a service layer. So configured, such a workload may be referred to as an application service instance (ASI). The infrastructure layer defines attributes such as compute, storage, and host operating system (OS) attributes. This layer can be provided and managed by either a 1^{st} or 3^{rd} party cloud provider or a private data center provider.

The ASI shown in the diagram 201 of FIG. 2 includes a collection 233 of components comprising a monolith service or a microservice. Such a collection 233 includes virtual machines 233a, containers 233b, and serverless functions 233c. The ASI shown in the diagram 201 encompasses a workload 235 deployed on a server. The workload 235 includes an infrastructure layer 235a, a virtual, i.e., virtualization layer 235b, and a service layer 235c. The infrastructure layer 235a includes physical hardware 237, persistent storage 239 available on the network, a host device 241 with a processor and memory, a physical network interface card 243, local storage 245, and a host operating system 247. The virtualization layer 235b may include a hypervisor 249, and a guest entity 251 that may include a virtual processor and memory. The virtual layer may also include a virtual network interface card 253, a virtual disk 255, and may have an operating system 257 installed thereupon. The virtual layer 235b also includes, for container applications, container mounts 259, container runtime components 261 and network plugin 263. The virtualization layer 235b may also include a serverless function handler 265. The hypervisor 249 of the virtual layer 235b may, through the operating system 257, connect to one or more virtual machines 233a that are part of the service layers 235c. Such virtual machines 233a may include handlers 279a, 279b, 279c, 279d, application programming interface (API) or web logic or databases 275a, 275b, third-party binaries 277a, operating system runtime binaries 280, web frameworks 269a, 269b, binary framework 271a, operating system services 273, and process name spaces 267a, 267b, 267c. In embodiments operating upon software configured as containers 233b, the service layer 235c includes handlers 279e, 279f, API or web logic or database 275c, web frameworks 269c, process namespace 267d, 267e, third-party binaries 277b, and binary frameworks 271b. In serverless configurations, a serverless function handler 265 interfaces with handles 279g, 279h, respectively through APIs or web or business logic functions 281, and binary functions 283.

The workload's virtualization layer 235b defines attributes such as a virtualization type, which may be implemented as a bare metal instance, a virtual machine instance, a container instance or a serverless function. This layer 235b can be provided and managed by either the 1^{st} party (where the application and infrastructure are owned and operated by the same entity) or by 3^{rd} parties (where the application and infrastructure are owned and operated by different entities).

The service layer 235c contains active code that provides the application's observable functionality. The service layer 235c can be powered by a mixture of OS and OS-provided runtime services (e.g., a host framework), one or more 1^{st} or 3^{rd} party precompiled executables and libraries (e.g., binary frameworks), and one or more 1^{st} or 3^{rd} party interpreted code files (e.g., interpreted frameworks).

Basis of Automatic Determination of Configuration Information

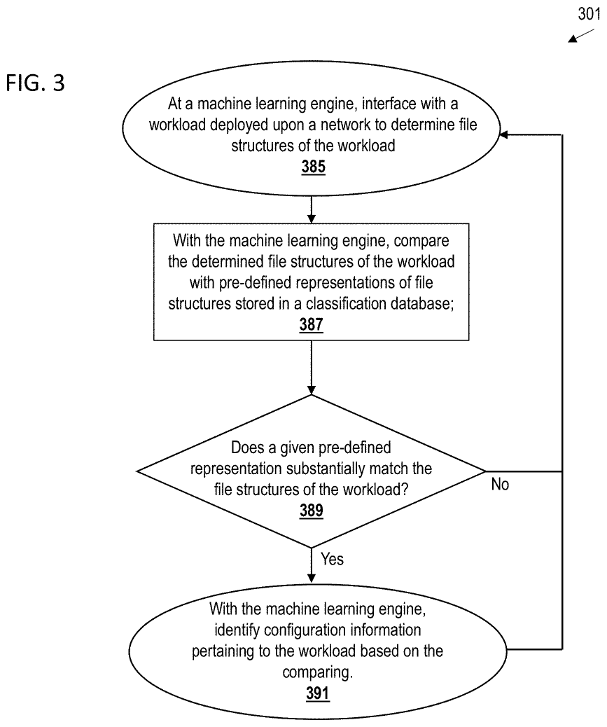

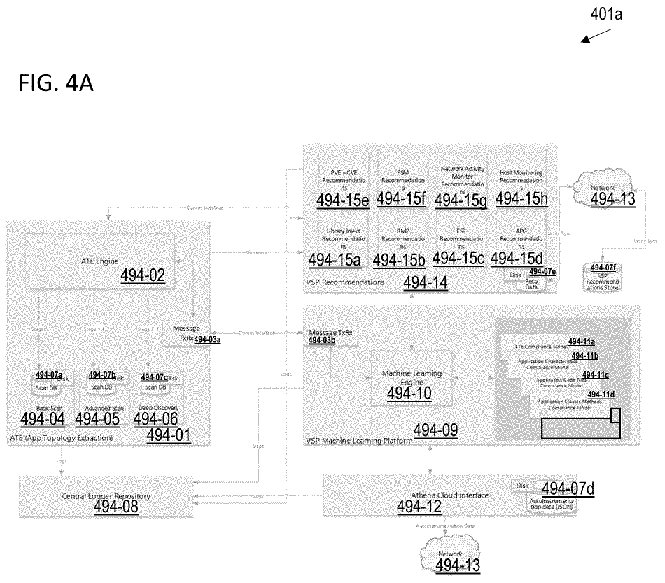

FIG. 3 is a flow diagram showing an example embodiment of a method 301 of determining configuration information pertaining to a workload. The method 301 begins at a machine learning engine by interfacing 385 with a workload deployed upon a network to determine file structures of the workload. The method 301 continues by comparing 387, with the machine learning engine, the determined file structures of the workload with predefined representations of file structures stored in a classification database. The classification database may be a framework discovery database. In turn, the method 301 evaluates 389 whether a given predefined representation substantially matches the file structures of the workload. If the result of the evaluation 389 is “no,” the method 301 returns to step 385 to continue monitoring the workload for changes that may introduce a file structure that may substantially match the file structure of the workload. If the result of the evaluation 389 is “yes,” the method 301 continues by identifying 391, with the machine learning engine, configuration information pertaining to the workload based on the comparing. After such an identification 391, the method 301 returns to step 385 for continuous monitoring as described above.

In some embodiments of the method 301, the workload includes at least one of a framework, an operating system, and a software application. In some embodiments, the workload includes hardware. In such embodiments, the hardware includes one or more processors, one or more memory devices, one or more storage devices, and one or more network adapters. In such embodiments, the method 301 further includes determining a status of a resource pertaining to the hardware tool by taking a pre-defined number of measurement samples at a node of the hardware tool, and comparing a function of the measurement samples with a pre-defined threshold value.

In some embodiments of the method 301, the configuration information is at least one of an identifier of a framework or library associated with the workload, and at least one of a language, a version, and a name of a framework, operating system, or application deployed upon the workload. An identifier of a library may be, for example, a name of a library file such as a .dll file. In some embodiments, the configuration information includes type details of a virtualization environment deployed upon the workload, wherein the type details include at least one of a designation as serverless, a designation as a container, and a designation as a virtual machine. In some embodiments, the method 301 further includes configuring the machine learning engine to modify representations of file structures stored within the classification database, or store additional representations of file structures within the classification database according to an update of a framework, operating system, or application, or creation of a new framework, operating system, or application.

In some embodiments of the method 301, the identifying 391 is informed by the evaluation 391 of the result of the comparing, wherein the evaluation 391 includes evaluating the result of the comparing with an accuracy threshold. Some embodiments further include automatically determining a protection action based on the identified configuration information, and issuing an indication of a recommendation of the determined protection action to a controller associated with the workload. Some such embodiments further include automatically selecting the recommendation from a recommendation database. In some embodiments, the recommendation is selected from the recommendation database by an end-user. In some embodiments, the method 301 further includes, prior to issuing the indication of the recommendation, augmenting a recommendation database in response to an input from an end-user defining the recommendation.

Some embodiments of the method 301 further include deploying software instrumentation upon the workload. The software instrumentation can be configured to determine real-time performance characteristics of the workload. In some such embodiments, the software instrumentation is further configured to indicate a condition of overload perceived at the workload. In some embodiments, the identified configuration information includes an indication of a vulnerability associated with the workload. In some such embodiments, the vulnerability is identified based on an examination of process memory. In such embodiments, the indication of the vulnerability further provides a quantification of security risk computed based on the examination of process memory. In some embodiments, the identified configuration information includes an indication of at least one file that is to be touched by a given process during a lifetime of the given process running upon the workload. In such embodiments, the method 301 includes constraining execution of the given process to prevent the given process from loading files other than the at least one file that is to be touched by the given process, thereby increasing trust in the given process.

In some embodiments, the workload includes a plurality of workloads. In some embodiments, a framework, an operating system, or an application is distributed or duplicated amongst the plurality of workloads. In some embodiments, the method 301 further includes constructing a topological representation of the plurality of workloads based on identified configuration information corresponding to respective workloads of the plurality thereof.

Overall Architecture of ATE-ML Engine

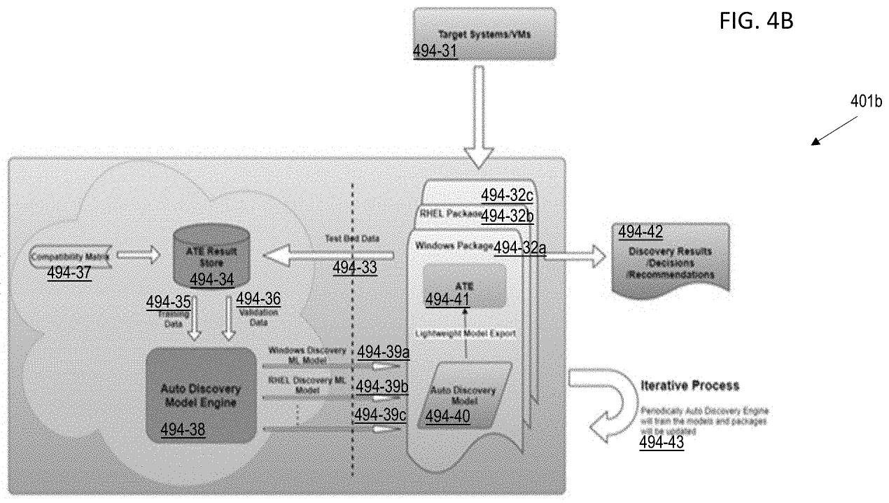

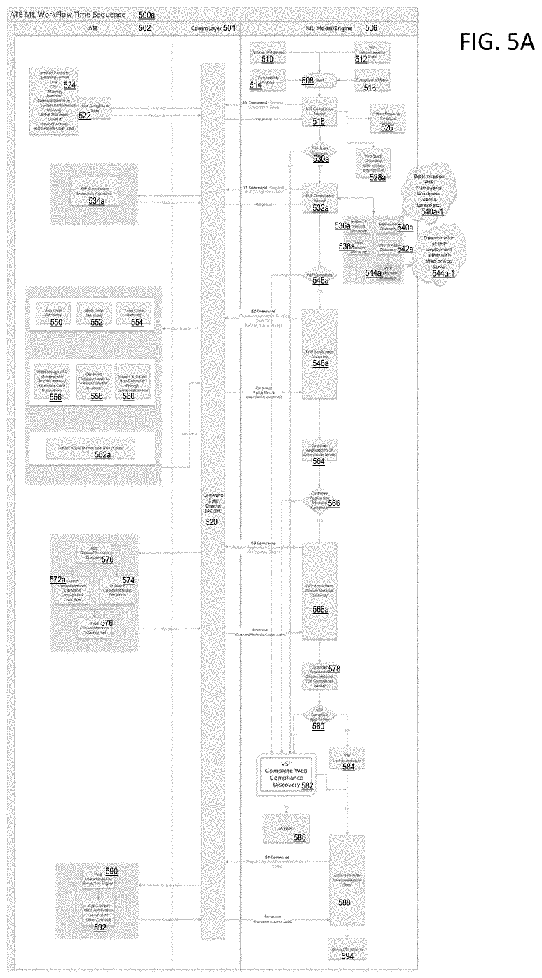

FIG. 4A is a schematic block diagram depicting an example embodiment of a system 401a for automatically determining configuration information pertaining to a workload. According to the embodiment, the system 401a includes an application topology extraction (ATE) module 494-01. The ATE 494-01 includes an ATE engine 494-02 and a message transmit-receive module 494-03a. The ATE 494-01 is configured to perform a basic scan 494-04 at stage zero, an advanced scan 494-05 at stages one and four, and a deep discovery scan 494-06 in stages two and three. Such basic 494-04, advanced 494-05, and deep discovery 494-06 scans respectively produce scan databases 494-07a, 494-07b, and 494-07c. The ATE 494-01 so enabled may communicate with a central logger repository 494-08. In turn, the central logger repository 494-08 may communicate with a cloud interface such as an Athena cloud interface 494-12, and a machine learning platform 494-09. The message transmit receive module 494-03a of the ATE 494-01 may interface with a corresponding message transmit receive unit 494-03b deployed within the machine learning platform 494-09. The machine learning platform 494-09 includes a machine learning engine 494-10 that communicates directly with the message transmit receive module 494-03b.

The ATE engine 494-02 and the machine learning engine 494-10 of FIG. 4A together comprise an aspect referred to herein as the ATE machine learning engine (ATE-ML engine). The machine learning engine 494-10 provides various compliance models including compliance models for the ATE 494-11a, for characteristics 494-11b of the workload (e.g. application), code files 494-11c of the workload (e.g., application), and classes and methods 494-11d of the workload (e.g., application). The machine learning platform 494-09 may interface with the cloud interface such as Athena 494-12, supported by a disk including auto segmentation JSON data 494-07d. The cloud interface 494-12 may connect to a larger network 494-13. In some embodiments, the machine learning platform 494-09 is configured to provide at least one recommendation 494-14 based on an evaluation by the machine learning engine 494-10 according to models 494-11a-d. Such recommendations 494-14 may include at least one of library injection 494-15a, runtime memory protection 494-15b, FSR 494-15c, APG 494-15d, PVE and CVE recommendations 494-15e, FSM recommendations 494-15f, network activity monitor recommendations 494-15g, and post monitoring recommendations 494-15h. Each such recommendations 494-15a-h may be deployed upon the network 494-13. The network 494-13 may also provide access to an offline storage location 494-07f.

Auto-Discovery and Auto-Compliance Procedures with ATE-ML Engine

The ATE-ML may be configured to perform auto-discovery and auto-compliance procedures. Such functionality may include basic scan 494-04, advanced scan 494-05, and deep discovery 494-06 as described hereinabove with reference to FIG. 4A. Such functionality may be performed in stages. As such, a Stage 0 may include basic scan 494-04, Stages 1 and 4 may include advanced scan, and stages 2 and 3 may include deep discovery.

In Stage 0 of the auto-discovery and auto-compliance procedures, the ATE-ML engine extracts baseline characteristics of a workload such as resources thereof (e.g., installed products, OS, disk, processor (CPU), memory, platform, and/or network interfaces). The ATE-ML engine may also extract real time performance characteristics for various system resources (e.g., available memory, CPU usage, and/or network traffic). The ATE-ML engine may also extract various processes characteristics (e.g., active processes, context, network activity, and/or process parent-child relationships). These aforementioned baseline characteristics may thus be used to establish an auto-discovery and auto-compliance profile.

A hardware profiling procedure, which may be subordinate to Stage 0 of the auto-discovery and auto-compliance procedures, may be performed by the ATE-ML engine for guest or host ASIs, and for instances of physical hardware used by the workload (including hardware used by a software application running on the workload), to ensure each guest ASI and each physical host ASI conforms to requirements and has enough head room in terms of available resources. In such a hardware profiling procedure, the ATE-ML engine may extract the resource information and performance information of each guest or physical host ASI. The ATE-ML engine will capture such data (e.g., on resource headroom) for each guest or host ASI for a period of x samples. Such a period may be the duration of resource utilization, may be programmable, and may be subject to a pre-defined default value.

Resource information and performance information of guest or physical host ASIs may include indicators such as: (i) number of physical/virtual cores associated with an ASI or an image deployed thereupon, (ii) CPU utilization—user, kernel and wait cycles system level, (iii) memory utilization—committed, working set, shared memory system level, (iv) memory utilization—total and free system memory on a host ASI or associated with an image deployed thereupon, (v) network address—IP address associated with each physical/virtual network adapter, (vi) network adapter—physical/virtual network adapters associated with a guest ASI, (vii) network utilization—receive and transmit I/O per physical/virtual adapter associated with a host ASI or an image deployed thereupon, (viii) disk access I/O—disk I/O for read and write operations at process level, (ix) disk space utilization—total and free disk space on a host ASI or an image deployed thereupon.

From performance indicators such as those mentioned above, the ATE-ML will create an aspect of the auto-discovery and auto-compliance profile specifically pertaining to resource requirements and utilization context. The ATE-ML engine may perform a threshold analysis and flag such indicators accordingly. For example, based on the performance analysis, if a CPU utilization threshold is crossed, the ATE-ML engine will flag the CPU utilization indicator and apply predefined heuristics to determine a next stage of operation.

In Stage 1 of the auto-discovery and auto-compliance procedures, the ATE-ML engine extracts “App+Web+Interpreter”-based vectors through a compliance extraction method. Data represented by these vectors may be evaluated by the ATE-ML engine according to various defined heuristics of compliance, to automatically determine a current and next stage of operation. For example, at Stage 1 on a .Net-based ASI, the ATE-ML engine may extract the .Net vectors (.Net framework, pipeline mode, etc.) to determine a current and next stage of operation. Such vectors may be further analyzed by the ATE-ML engine to augment or update the auto-discovery and auto-compliance profile.

In Stage 2 of the auto-discovery and auto-compliance procedures, the ATE-ML engine performs a first phase of deep discovery using various techniques to extract “App+Web+Interpreter”-specific details. Such details may include application code files, web framework-related code files, etc. The deep discovery method may apply techniques such as iterative Virtual Address Descriptor (VAD) extraction of an interpreter process, clustered directory traversal to extract code files, inspection, and extraction of application topology through application- or web server-aware structured files, such as configuration files. Once the extractions are complete, the ATE-ML engine structures the extracted application code and web server code files in pre-defined formats (as they are found on the platform). Such clustered and VAD data vectors may be further analyzed by the ATE-ML engine to augment or update the auto-discovery and auto-compliance profile. For example, at Stage 2, the ATE-ML engine may identify the applications, their web context locations, and their infrastructure present in the system (i.e., workload) in real time.

In Stage 3 of the auto-discovery & auto-compliance procedures, the ATE-ML engine performs a second phase of deep discovery using various techniques to extract “App+Web+Interpreter”-specific details, such as “Classes+Methods” hierarchy and relationships. The deep discovery method applies techniques such as RegEx extractions on plaintext code files, assembly extractions for managed code modules, and Import Address Table (IAT) parsing for imported functions for native code modules. RegEx extractions are very application-specific techniques since structures of classes and methods are highly based on semantics of the languages of “Application+Web” server development. Once the extractions are complete, the ATE-ML engine will structure the extracted application and web server Classes+Methods relationships in defined formats, as they are found on the platform during the discovery phase.

The data acquired by deep discovery in Stages 2 and 3 will be used by the ATE-ML engine to apply the modelling and determine the compliance results. The ATE-ML engine takes many inputs from different sources, such as vulnerability profiles and a compliance matrix. Once the compliance results are determined, the ATE-ML engine will proceed to Stage 4 of the auto-discovery and auto-compliance procedures, which include an auto-instrumentation sub-procedure.

In Stage 4 of the auto-discovery and auto-compliance procedures, the ATE-ML engine performs a set of final data extractions in support of instrumenting the workloads in the server environments. The ATE-ML engine will execute an application instrumentation extraction method to retrieve the data, which will, in turn, be integrated in a JSON structure by the ATE-ML engine, to support an auto-instrumentation workflow.

Below is the structural format of the aforementioned JSON structure according to an example implementation:

```
{
  “cms”: {
  “management_ip”: “1.1.1.1”,
  “users”: [
    {
    “first name”: “testuser”,
    “last name”: “testuserlname”,
    “email”: “test@test.com”,
    “password”: “124Test@123”,
    “phone_number”: “9898989998”,
    “is_super_admin”: true
    }
  ]
  },
  “lfr”: {
    “lfr_sync_required”: false,
    “deployment”: true,
    “location_id”: “5f846d4c8543f0777750d6d1”,
    “vsp_version_no”: “1.1”,
  “ip”: “1.1.1.88”
  },
  “application”: {
    “name”: “Mon App Infra”,
    “version”: “Mon App Infra”,
    “locations”: [
    {
      “name”: “L1”,
      “cloud type”: “Amazon S3”,
      “subnets”: [
      {
        “name”: “masub”,
        “asis”: [ ],
        “aes”: [
        {
          “name”: “Mon AE”,
          “deployment”: true,
          “virtual_teches”: {
          “virtualisation_type”: “Hypervisor”,
          “sub_type”: “Ova”,
          “virtual_volume_name”: “Hypervisor called ova”
          },
          “guest_details”: {
          “credentials”: {
            “username”: “testuser”,
            “password”: “abcd@l23$Sloping”
          },
          “domain”: “domain.com”
          },
          “v_nics”: [
          {
            “name”: “test vnic ae”,
            “ip”: “1.1.1.1”,
            “vsp_channel_type”: “Management”
          },
          {
            “name”: “test vnic ae 2”,
            “ip”: “1.1.14.4”,
            “vsp_channel_type”: “Data”
          }
          ],
          “compute_instance_name”: “AE”
        }
        ]
      },
      {
        “name”: “new sub”,
        “asis”: [
{
        “name”: “ASI Exp”,
        “location id”: “5f846d588543f0777750d6d2”,
        “credentials”: {
          “username”: “usertestexp”,
          “password”: “111111”
        },
        “data ip”: “1.1.1.3”,
        “management_ip”: “1.1.1.1”,
        “frameworks”: [
          {
          “name”: “Framework Exp”,
          “interpreted_framework”: “IBM Websphere App Server 9
          (VSP 1.3+)”,
          “interpreter”: “JAVA”,
          “os”: {
            “name”: “Windows”,
            “version”: “Microsoft windows server 2016”
          },
          “processes”: [
            {
            “name”: “Process Exp 2”,
            “info”: {
              “name”: “atest”,
              “description”: “asd”
            },
            “version”: “asd”,
            “executable_directories”: {
              “name”: “bro”,
              “version”: “fp2”,
              “binary_folder”: “/bro”
            },
            “acls”: [
              {
              “permission”: “per”,
              “existing_group”: “exis”,
              “members”: “mem”
              }
            ]
            }
          ],
          “services”: [ ]
          },
          {
          “name”: “test framework”,
          “interpreted_framework”: “Flask”,
          “interpreter”: “Javascript”,
          “os”: {
  “name”: “RHEL”,
            “version”: “7”
          },
          “processes”: [
            {
            “name”: “prol”,
            “info”: {
              “name”: “pr02”,
              “description”: “prod”
            },
            “version”: “1”,
            “created_time”: “2020-09-24T13:18:37.813Z”,
            “modified_time”: “2020-09-24T13:18:37.813Z”,
            “acls”: [ ]
            }
          ],
          “services”: [ ]
          }
        ]
        },
        {
        “name”: “test alpha”,
        “location_id”: “5f846d588543f0777750d6d2”,
        “frameworks”: [
          {
          “name”: “Framework Exp”,
          “interpreted_framework”: “IBM Websphere App Server 9
          (VSP 1.3+)”,
          “interpreter”: “JAVA”,
          “os”: {
            “name”: “Windows”,
            “version”: “Microsoft windows server 2016”
          },
          “processes”: [
            {
            “name”: “Process Exp 2”,
            “info”: {
              “name”: “atest”,
              “description”: “asd”
            },
            “version”: “asd”,
            “executable_directories”: {
              “name”: “bro”,
              “version”: “fp2”,
              “binary_folder”: “/bro”
            },
            “acls”: [
              {
“permission”: “per”,
              “existing_group”: “exis”,
              “members”: “mem”
              }
            ]
            }
          ],
          “services”: [ ]
          },
          {
          “name”: “test framework beta”,
          “interpreted_framework”: “Flask”,
          “interpreter”: “Javascript”,
          “os”: {
            “name”: “RHEL”,
            “version”: “7”
          },
          “processes”: [
            {
            “name”: “pro1”,
            “info”: {
              “name”: “pr02”,
              “description”: “prod”
            },
            “version”: “1”,
            “created_time”: “2020-09-24T13:18:37.813Z”,
            “modified_time”: “2020-09-24T13: 18:37.813Z”,
            “acls”: [ ]
            }
          ],
          “services”: [ ]
          }
        ]
        }
      ],
      “aes”: [
        {
        “name”: “Mon AE 2”,
        “deployment”: true,
        “virtual_teches”: {
          “virtualisation_type”: “Container”,
          “sub_type”: “Docker”,
          “virtual_volume_name”: “dockvol”
        },
        “guest_details”: { },
        “v_nics”: [ ],
        “compute_instance_name”: “CMS”
        },
{
        “name”: “Mon AE 3”,
        “deployment”: true,
        “virtual_teches”: {
          “virtualisation_type”: “Hypervisor”,
          “sub_type”: “Arm”,
          “virtual_volume_name”: “amr2”
        },
        “guest_details”: { },
        “v_nics”: [
          {
          “name”: “mvnic”,
          “ip”: “1.1.1.7”,
          “vsp_channel_type”: “Data”
          },
          {
          “name”: “mt2”,
          “ip”: “1.1.1.6”,
          “vsp_channel_type”: “Management”
          }
        ],
        “compute_instance_name”: “LFR”
        }
      ]
      }
    ],
    “apgs”: [ ]
  ]
  }
}
```

Predictive and Explanatory Models for ATE-ML Engine

The ATE-ML engine includes several predictive & explanatory models. One purpose of this engine is to provide recommendations to control or influence the auto-discovery phase, and, from there, produce a partially filled template of Instrumentation JSON.

FIG. 4B is a block diagram depicting overall architecture 401b of such models. According to the embodiment, a target system 494-31 is chosen. Target system 494-31 may be virtual. Depending upon an operating system of the target system 494-31, packages chosen may be a Windows package 494-32a, a Linux package such as a Red Hat Linux package 494-32b or another type of package 494-32c. Initially, a set of test bed data 494-33 may be run through the system 494-31, producing configuration information to be stored in the ATE result store 494-34. A compatibility matrix 494-35 may provide data to the ATE results store 494-34 so as to train the model to adapt to variations in the workloads of such version. In an initial case, or periodically when updates or refinements are released, training data 494-36 is pulled from the ATE results store 494-34 to train the machine learning enabled auto-discovery model engine 494-38. Subsequently, validation data 494-37b may be run through the auto-discovery model engine 494-38 to ensure accuracy of training. After training and validation, auto-discovery model engine 494-38 may apply a Windows discovery machine learning model 494-39a, a Linux model such as a Red Hat Linux discovery machine learning model 494-39b, or another model 494-39c, depending upon the operating system deployed upon the workload. An auto-discovery model 494-40 may be thus produced and exported to an application topology extractor (ATE) 494-41. Results 494-42 may include configuration information and decisions or recommendations associated therewith. The model 401b of FIG. 4B is an iterative process 494-43 that includes periodically training and updating models and packages used in determining configuration information, and continuously scanning workloads to maintain updated configuration information.

In an embodiment, all models are built on top of results produced by the ATE-ML engine (i.e., ATE results) during the auto-discovery and auto-compliance procedures and stored in a master database. Predictive models may include classifiers, which can identify the installed and running server components on target systems in the auto-discovery phase of FIG. 4B. There may be specific models for different OS types (e.g., Windows, Linux). Under each OS type, there may be further divisions between models for different types of server components. For example, database discovery and web application server discovery may have separate models. All these predictive models consume ATE-ML engine output as input and produce data classifying server components and other server statistics as output. Choice of underlying machine learning (ML) methods varies from model to model (e.g., random forest, logistic regression).

Explainability of ML models helps to produce recommendations to be fed into Instrumentation JSON in the Discovery Results phase of FIG. 4B. According to an embodiment, explainable AI (XAI)-based methods are used to interpret a model and find out a reason for a prediction. For example, if a remote system is classified by the predictive model to have a web server, then XAI-based approaches help to identify processes and services responsible for running that web server. Such XAI-based methods may include standard model-specific explanatory methods or more robust model-agnostic methods such as game theory-based approaches.

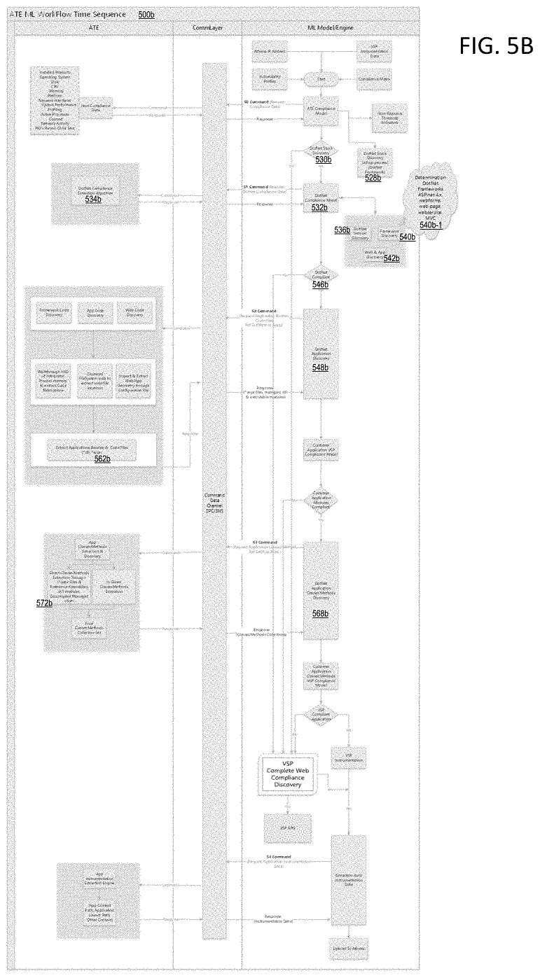

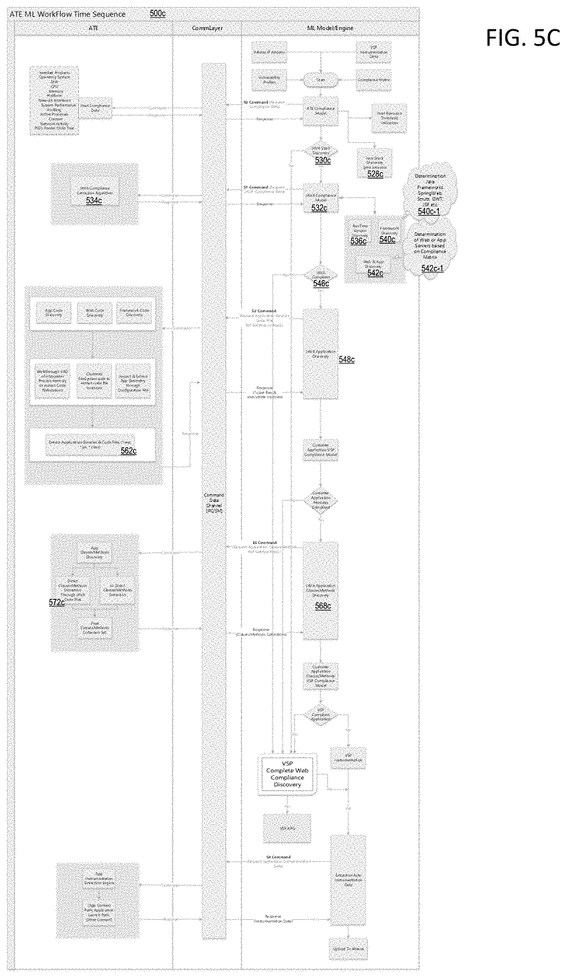

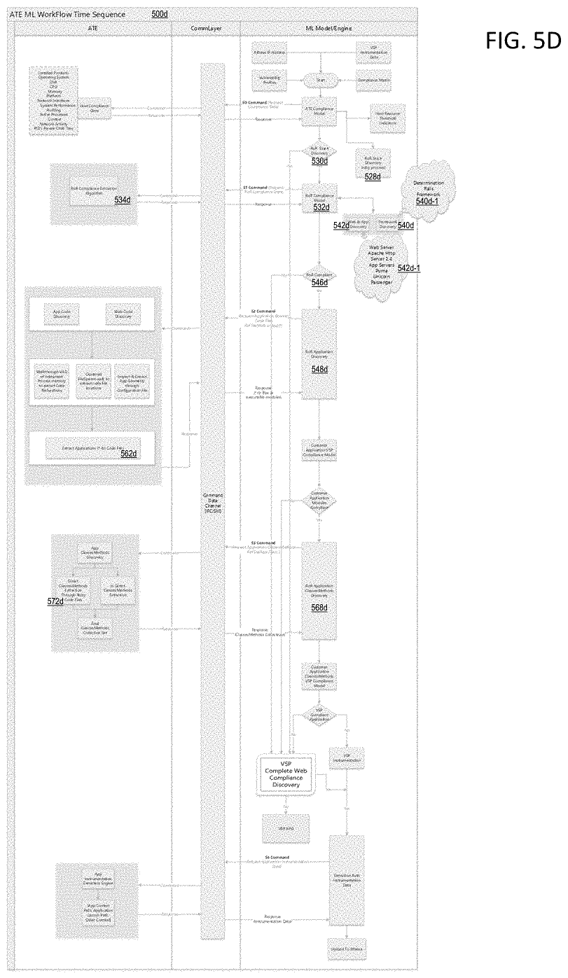

FIG. 5A shows an example time sequence 500a for an embodiment of an application topology extractor machine learning workflow to be used in conjunction with a PUP workload. The time sequence 500a includes actions performed by an application topology extracting module 502, a communications layer 504, and a machine learning ML engine equipped with a ML model 506. The time sequence 500a starts at step 508 having been supplied with an IP location such as an Athena IP address 510 of a workload, and having been supplied with instrumentation data 512, vulnerability profiles 514, and a compatibility matrix 516. Items 510, 512, 514, 516 serve as inputs to an ATE compliance model 518. A workload may be configured as an ASI, i.e., a host. Compliance data 522 pertaining to such a host may be provided via a command data channel 520 of the communications layer 504. Such host compliance data 522 may include examples 527 pertaining to installed hardware products, operating system, disk, processor (CPU), memory, platform, network interfaces, system performance, profiling, active processes, context, network activity, and process identifications (PID) which may include indications of parent-child relationships among processes. The ATE compliance model 518 interfaces with host resource threshold interpreters 526 and performs a PHP stack discovery process 528a. If a PUP stack is not discovered, web compliance discovery completes 582; otherwise, if a PUP stack is discovered 530a, the sequence proceeds to implementation of a PUP compliance model 532a and execution of a PUP compliance extractor method 534a, to discover various attribute aspects of the workload. Such aspects may include PUP NTS version discovery 536a, Zend version discovery 538a, framework discovery 540a, web and application discovery 542a, and PUP deployment discovery 544a. Framework discovery 540a may discover example frameworks 540a-1 such as WordPress, Joomla!, and Laravel, amongst others. PUP deployment discovery 544a may determine 544a-1 deployment with either a web or application server. If the workload is not found to be PUP compliant, web compliance discovery completes 582; otherwise, if the workload is found to be PUP compliant 546a, a PHP application discovery process 548a is run. The PHP application discovery process 548a includes application code discovery 550, web code discovery 552, Zend code discovery 544, a walkthrough VAD of interpreter process memory to extract code file locations 556, a walkthrough of clustered file systems to extract code file locations 558, and inspection and extraction of application topology (i.e., geometry) through a configuration file 560. The process 548a thereby extracts application PHP code files 562a. Subsequently, a customer application clients model 564 is applied. If the customer application client model 564 is not found to be compliant, web compliance discovery completes 582; otherwise, if the customer application client model 564 is found to be compliant, the machine learning engine 506 proceeds to discovery of PHP application classes and methods 568a. Discovery of PHP application classes and methods 568a may include discovery, by the ATE, of application classes and methods 570, which, in turn, may include direct class/method extraction through PHP code files 572a, and indirect class/method extraction 574. Such functionality produces a final class/method collection set 576 to be applied to a customer application class and methods compliance model 578. If the application is not found to be compliant, web compliance discovery completes 582; otherwise, instrumentation 584 is deployed upon the application 584. If web compliance discovery is unable to complete, an APG is consulted 586; otherwise, extraction auto-instrumentation data 588, provided by the applied instrumentation 584, is uploaded 594 to the cloud, e.g., Athena. Such extraction auto-instrumentation data may be provided by an application instrumentation extraction engine 590, and may include data 592 such as at least an application context path, application launch path, and other context.

FIG. 5B shows an example ATE-ML workflow time sequence 500b of the application discovery of a .Net workload. The sequence 500b proceeds in a similar fashion as the sequence 500a for a PUP workload. Differences therebetween include a .Net stack discovery process 528b, an evaluation 530b thereof, extraction 534b of the .Net compliance model 532b, and aspects of the .Net compliance model 532b including .Net version discovery 536b, framework discovery 540b, and web and application discovery 542b. Framework discovery 540b for .Net may include determinations 540b-1 of ASP.net, 4.x, webforms, web pages, web services, and MVC. The .Net compliance evaluation 546b is performed subsequently. A .Net application discovery 548b is performed to extract code files including application binaries and code files such as .dll and .aspx files 562b. A .Net application class and method discovery process 568b may include data obtained through direct class method extraction 572b through files such as .aspx files, reference assemblies, IAT modules, and decompiled managed code.

FIG. 5C shows an example ATE-ML workflow time sequence 500c of the application discovery of a Java workload. The sequence 500c proceeds in a similar fashion as the sequences 500a and 500b for PUP and .Net workloads described hereinabove in relation to FIGS. 5A and 5B, respectively. Differences therebetween include a Java stack discovery process 528c and evaluation 530c thereof, extraction 534c of the Java compliance model 532c, and aspects of the Java compliance model 532c including runtime version discovery 536c, framework discovery 540c, and web and application discovery 542c. Framework discovery 540c for Java may include determinations 540c-1 of SpringWeb, Struts, GWT, JSF, etc. Web and application discovery 542c may include determinations 542c-1 of web or application servers based on the compliance matrix. The Java compliance evaluation 546c is performed subsequently. A Java application discovery 548c is performed to extract code files including application binaries and code files such as .war, .jar, and class files 562c. A Java application class and method discovery process 568c may include direct class and method extraction 572c through files such as Java code files.

FIG. 5D shows an example ATE-ML workflow time sequence 500d of the application discovery of a Ruby on Rails (RoR) workload. The sequence 500d proceeds in a similar fashion as the sequences 500a, 500b, and 500c for PUP, .Net, and Java workloads described hereinabove in relation to FIGS. 5A, 5B, and 5C, respectively. Differences therebetween include a RoR stack discovery process 528d and evaluation 530d thereof, extraction 534d of the RoR compliance model 532d, and aspects of the RoR compliance model 532d including framework discovery 540d and web and application discovery 542d. Framework discovery 540d for RoR may include determinations 540d-1 of a Rails framework. Web and application discovery 542d may include determinations 542d-1 of an Apache HTTP Server, e.g., version 2.4, or application servers such as Puma, Unicorn, or Passenger. The RoR compliance evaluation 546d is performed subsequently. A RoR application discovery 548d is performed to extract code files including application code files such as .rb files 562d. A RoR application class and method discovery process 568d may include direct class and method extraction 572d through files such as Ruby code files.

FIG. 5E shows an example ATE-ML workflow time sequence 500e of the application discovery of a Node.js workload. The sequence 500e proceeds in a similar fashion as the sequences 500a, 500b, 500c, and 500d for PUP, .Net, Java, and RoR workloads described hereinabove in relation to FIGS. 5A, 5B, 5C, and 5D, respectively. Differences therebetween include a Node.js stack discovery process 528e and evaluation 530e thereof, extraction 534e of the Node.js compliance model 532e, and aspects of the Node.js compliance model 532e including framework discovery 540e. Framework discovery 540e for Node.js may include determinations 540e-1 of Express, HTTP/S, Node.ts, etc. The Node.js compliance evaluation 546e is performed subsequently. A Node.js application discovery 548e is performed to extract code files including application code files such as .js files 562e. A Node.js application class and method discovery process 568e may include direct class and method extraction 572e through files such as Node.js code files.

Phases of Initial Provision of ACM Functionality

An initial MVP phase of provisioning an auto-configuration manager (ACM) involves delivering a ML model for all web frameworks already on the existing compatibility matrix, for initial deployment in virtual machine (VM) form factor in the customer setup. This phase will allow the ACM to discover and provision host-monitoring, web-monitoring, and memory-monitoring capabilities on an on-demand basis, to support automatic determination of configuration information of hosting aspects, remote web service aspects, and local memory aspects of a workload.

In Phase 2, the ACM may add further automation such that the customer does not have to perform on-demand provisioning. The ACM will discover that the homeostasis has been disturbed automatically. As a result, the customer simply takes a maintenance window in which the ACM will reprovision a cloud-management solution (CMS) automatically.

In Phase 3, the ACM will provision both VM-based and container-based workloads. For container based applications, the ACM may output a CMS-appropriate package manager manifest. In this case, both the container runtime file as well as the overall deployment manifest will be fully ready. The ACM stacks the customer's provisioning tool (e.g., helm, terraform, etc.) with appropriate monitoring and protection modules.

In Phase 4, the ACM will provision the workloads directly instead of via the CMS. In this case, workloads will come up fully protected. This is needed because with serverless virtualization, there would not be enough time to perform provisioning through the CMS because this operation can take minutes.

Please note that changing a web application's business logic does not require a rediscovery; it is only necessary to do so when the framework code is changed.

AppMaps

In embodiments in which a workload includes a software application, determined configuration information pertaining to the application may be stored in various application-aware maps (AppMaps) to ensure that the application always operates within a predetermined set of guardrails at runtime.

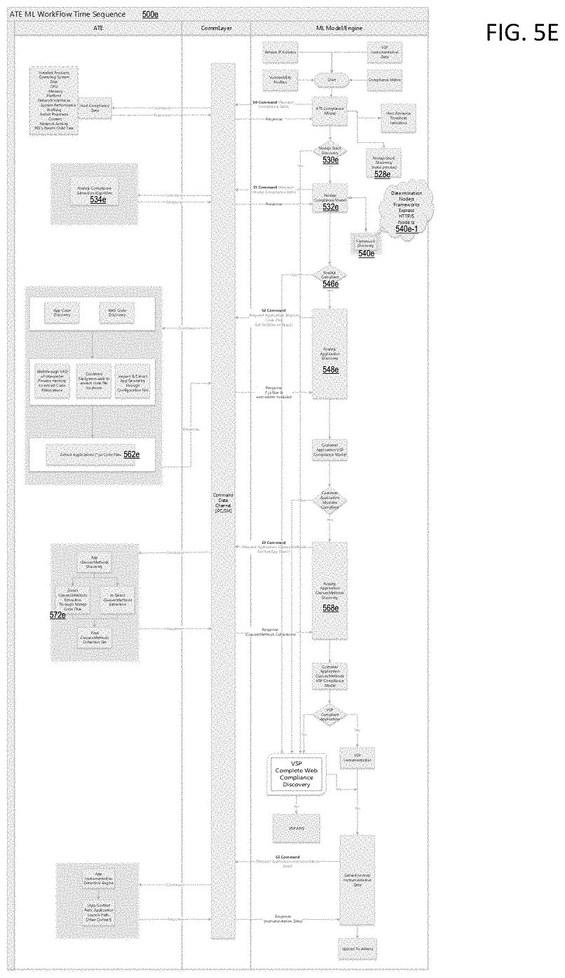

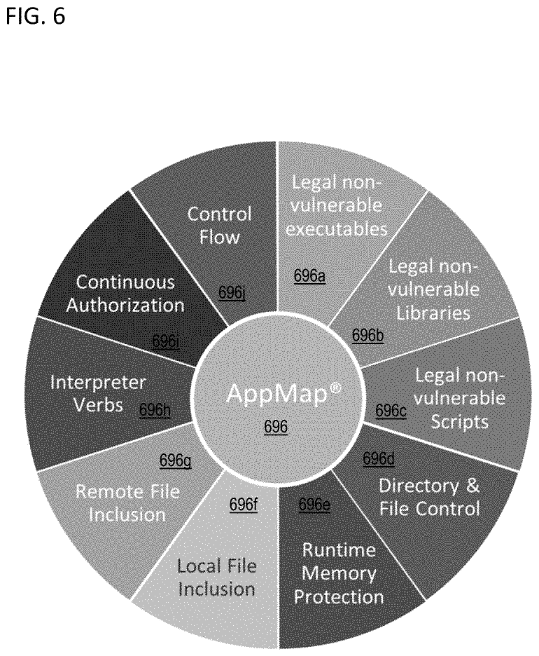

FIG. 6 depicts various application maps, i.e., AppMaps 696, supported by embodiments. AppMaps 696a-e are imposed by a host-monitoring module. AppMaps 696f-i are imposed by a web-monitoring module, and the AppMap 696i is imposed by a memory-monitoring module. Such AppMaps 696 include maps of legal non-vulnerable executables 696a, legal non-vulnerable libraries 696b, legal non-vulnerable scripts 696c, directory and file control 696d, runtime memory protection 696e, local file inclusion 696f, remote file inclusion 696g, interpreter verbs 696h, continuous authorization 696i, and control flow 696j.

Automated Configuration and Reconfiguration of ATE-ML Engine by ACM

Since applications are constantly evolving, sometimes as often as multiple times a day, the ATE-ML engine is configured to identify compatible web and binary application frameworks. This configuration of the ATE-ML engine may have two components: a static component, and a runtime component.

The static component involves (i) finding files on disk and identifying a cluster of executable files that are rooted at a directory location that may change from installation to installation but not relative to each other, and (ii) finding one or more configuration files that determine “configurable options” for a given framework.

The dynamic component involves (i) performing a sufficiently exhaustive do-no-harm test that exercises enough functionality of the application such that as many executables as are part of the application are loaded in memory, (ii) instrumenting the executables and determining that there is no adverse impact on the application's functionality, and (iii) recording the performance overhead, not only in terms of CPU and memory bloat, but also in terms of latency and overhead.

While the static component is rigid and does not change as easily, the dynamic component has a strong dependency on the do-no-harm test. Therefore, the ACM is able to adapt to newly detected changes.

An initial qualification can be done in a qualification testing lab of a solution provider using a standard do-no-harm test. However, if a customer has a specific do-no-harm test, then the customer can provide the same to the solution provider for use in its lab.

To summarize, there are various reasons that the deployment homeostasis of a given application can trigger (re)discovery of a web or binary framework, including (i) a customer changes or adds framework code on the disk relative to the baseline framework used by a qualification team of the solution provider to initially train the ATE-ML engine, (ii) a legal executable in the package starts running for the very first time and such a process is not included in the ML model developed by the solution provider's qualification team, (iii) the qualification team has released a fresh or modified an existing, qualified framework, and (iv) a customer may decide to run different protection actions from those specified by the initial qualification.

ACM Architecture

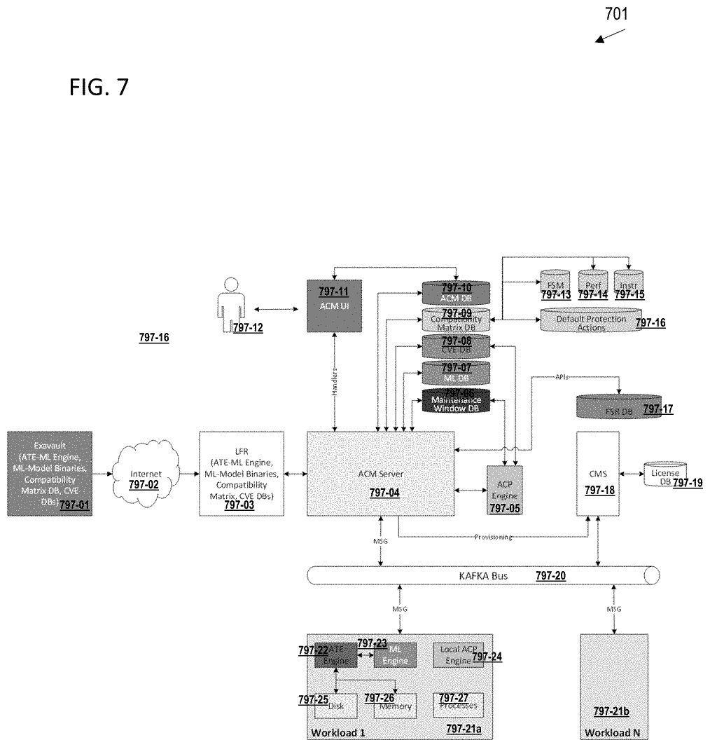

FIG. 7 is a schematic block diagram depicting ACM infrastructure architecture 701. The overall solution 701 includes the following subsystems: (i) ML engine 797-23 training—used in a continuous integration pipeline or lab only, (ii) ML engine 797-23 qualification workflows—used in the continuous integration pipeline or lab only, (iii) compatibility matrix 797-09 workflows, (iv) ACM 797-04—ATE engine 797-22 communication workflows, (iv) ACM 797-04—LFR 797-03 communication workflows, (v) ACM 797-04—CMS 797-18 communication workflows, (vi) ACM user interface (UI) 797-11 workflows, and (vii) ACP engine 797-05, i.e., ACP extraction engine, workflows.

The system 701 can be employed to implement a method, e.g., the method 301, for determining configuration information of a workload. Beginning from an FTP location such as Exavault 797-01, via the Internet 797-02, and through a local file repository (LFR) 797-03, an ACM server 797-04 interfaces with an ACP engine 797-05 to connect with a maintenance window database 797-06 and a CVE database 797-08. The ACM server 797-04 also connects with a machine learning database 797-07, compatibility matrix database 797-09, and an ACM database 797-10. The ACM database 797-10 may be connected back to the ACM server 797-04 by handlers of the ACM user interface 797-11. A user 797-12 may, through the ACM user interface 797-11, access the ACM database 797-10. The compatibility matrix database 797-09 may include information such as FSM data 797-13, performance data 797-14, instrumentation data 797-15, and default protection actions 797-16. The ECM server 797-04 may additionally interface with a FSR database 797-17. The ACM server 797-04 may be provisioned upon a CMS 797-18 which has access to a license database 797-19. CMS 797-18 and the ACM server 797-04 may, in a parallel manner, connect to a software bus, e.g., a Kafka bus 797-20, which connects the various workloads, including a first workload 797-21a and an Nth workload 797-21b. Such workloads may include an ATE engine 797-22, a machine learning engine 797-23, a local ACP engine 797-24, disk 797-25 for non-transitory storage, memory 797-26, and definitions of processes 797-27.

ML Training and Qualification Workflow

From time to time, a solution provider a host, binary, or web framework for qualification. First, a list of executables associated with each targeted framework(s) may be fed into ML Training tables. Next, Do-No-Harm (DNH) tests may be performed on the targeted framework(s). The goal of the DNH tests is to ensure that as much code coverage as possible is obtained, as many processes as possible are exercised, and as many libraries as possible get loaded in those processes. In case of web applications, a high-quality crawler can be used to exercise as much of the web application as possible. Reference can also be made to QA sites and GitHub where users may have checked in scripts used to exercise and test the said framework. This is especially true of open-source code.

The DNH test may be run with and without the security solution to determine performance impact. Please note that the ATE can be run for a variable amount of time and data capture is cumulative. For example, all processes that ran and all files that got loaded into memory are cumulative and this forms the basis of FSM data associated with the framework under qualification. Processes whose executable is in the package associated with the framework, or any children processes associated with the aforementioned executables, may be targeted.

In case of non-web applications or compiled binaries, the goal would be to capture compute and memory overheads, whereas, for web applications, the goal would be to additionally capture latency and throughput impacts of instrumentation features.

The output of the qualification process would be to (i) enumerate, for each process, which of four-instrumentation modes (foreground process, background service, or child process with or without inherited environment) was used, (ii) generate an instrumentation script for each process for each mode, (iii) generate a rollback script for each process for each mode, (iv) generate an FSM for each process for each mode, and (v) recommend and test the default protection action(s) associated with the framework.

An additional goal of the qualification process may be to identify configurable options in the framework under test in order to specify which vulnerability related data was captured.

Compatibility Matrix Workflows

As part of new onboarding activity, not only do new frameworks get added into the compatibility matrix, but the corresponding instrumentation and rollback scripts, performance impact and default protection action script(s) get identified.

It is also possible that some aspects of instrumentation may not work on a given framework when used in a specific configuration or in process instrumentation mode. This information is captured in the compatibility matrix. The matrix is a working document and, therefore, it is able to reflect cases in which an instrumentation aspect was not working on a given day, but was working again on another given day. As a result, the ACM reads the compatibility matrix prior to provisioning to obtain the correct instrumentation or rollback mode and the appropriate vulnerability protection profile for a given application.

ACM Server—ATE Communication Channel

The ACM server or the ATE can trigger events indicating some activity must be performed at the other end. When the messages are flowing from the ACM to the ATE, the ATE can leverage one or more .csv files it generates as part of a full scan. An example of a message like this is “Discover Web Framework(s).”

When the ATE dispatches messages to the ACM, it either responds to a previously asked ACM request or an asynchronous event at the workload. An example of a previously asked ACM request would be “Discover Web Framework(s).” An example of an asynchronous event would be a “New Workload Registration” message.

In either scenario, the sender will maintain a current state and last sent message type and timestamp to facilitate debugging.

ACM—LFR Communication Workflows

Three communication databases may be maintained by the solution provider and leveraged by users. These databases include (i) ML (training and qualification) database, (ii) CVE (NVD-CPE, CVE-Package, CVE-Executable-ACP, MITRE ACP Policies) databases, and (iii) compatibility matrix. In addition to these databases, the solution provider can also release a new version of an OS-dependent ATE-ML package. These databases and packages may be uploaded in Exavault (or other repository manager) from where the customer's local file repository (LFR) syncs periodically.

Packages are meant for use by customer IT, but the databases are meant for use by the ACM Server infrastructure. The databases are incremental in nature and can be updated by the solution provider at an arbitrary frequency. Therefore, the workflow involves (i) the LFR detecting that a new update has arrived, (ii) the LFR informing the ACM of the arrival, and (iii) the ACM leveraging appropriate scripts to insert the appropriate differential database into the cumulative database for the ACM server to leverage.

For the above purpose, the LFR-ACM communications path may be a Client-Server TCP based IPC communications path. The LFR acts as the client while the ACM server is the server. The messaging channel is described in the section below.

ACM—CMS Communication Workflows

As new applications get created, updated, or deleted, the ACM needs to communicate with the CMS and update the provisioning databases in the CMS. The CMS offers a plurality of APIs that are used for this purpose. Provisioning is different for host, web and binary Frameworks. Provisioning not only describes how to setup/tear down an application, but also involves setting up a vulnerability profile, setting up protection actions, and SecOps users. Currently, there is no need for the CMS to communicate with the ACM; therefore, the communication is implemented in one direction only.

Interpreted and Binary Framework Discovery

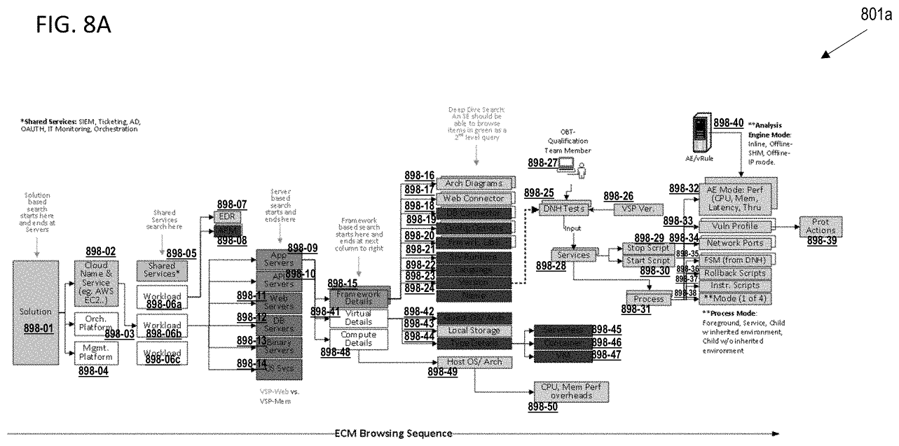

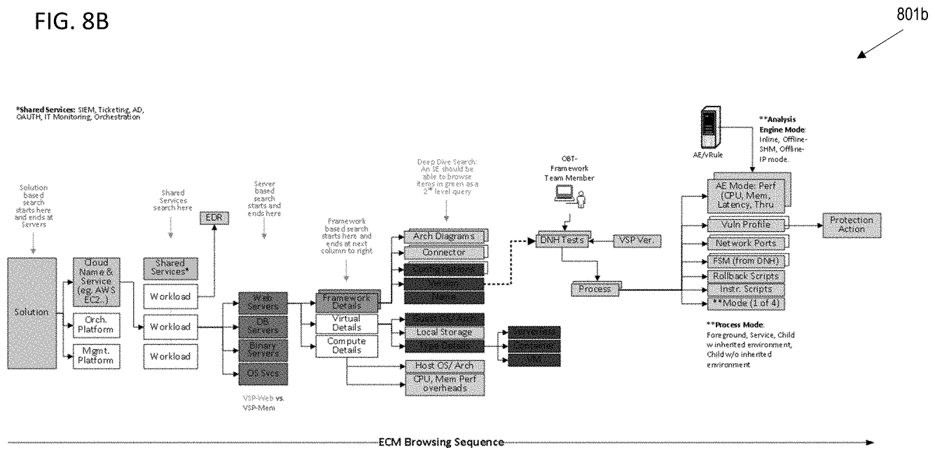

FIG. 8A is a flow diagram showing an example workflow 801a for discovery of interpreted frameworks. The workflow 801a begins with a solution 898-01 configured to search a cloud service 898-02, an orchestration platform 898-03, and a management platform 898-04. The cloud service 898-02, interfaces with shared services 898-05 and various workloads 898-06a, 898-06b, and 898-06c. The workloads 898-06a, 898-06b, 898-06c may interface with an associated EDR 898-07 and APM 898-08. The workloads 898-06a, 898-06b, 898-06c may interface with associated application server(s) 898-09, API server(s) 898-10, web server(s) 898-11, database server(s) 898-12, binary server(s) 898-13, and operating system server(s) or service(s) 898-14. Application servers may be searched by the solution 898-01 for framework details 898-15. Such framework details 898-15 include architecture diagrams 898-16, a web connector 898-17, database connector 898-18, configuration options 898-19, framework libraries 898-20, server runtime 898-21, language 898-22, version 898-23, and name 898-24. Version 898-25 may be determined by do-no-harm (DNH) tests 898-25 depending upon a version 898-26 of the solution 898-01. Such DNH tests may be performed by a qualification team member 898-27 of a solution provider. Such DNH tests 898-25 may influence service(s) 898-28 to stop 898-29 or start 898-30 a script, or otherwise control aspects of processes 898-31 such as analysis engine mode 898-32, vulnerability profile 898-33, network ports 898-34, FSM 898-35, rollback scripts 898-36, instrumentation scripts 898-37, and a process mode 898-38. A vulnerability profile 898-33 may define protection actions 898-39.

FIG. 8B is a flow diagram showing an example workflow 801b for discovery of binary frameworks. A network environment may be evaluated for such binary frameworks in a manner similar to that described by the interpreted software framework discovery workflow 801a introduced hereinabove and depicted in FIG. 8A, but for omission of APM 898-08, application server(s) 898-09, API server(s) 898-10, database connector 898-18, framework libraries 898-20, server runtime 898-21, language 898-22, and in control of services 898-28 such as stopping 898-29 and starting a 898-30 scripts based upon results of DNH tests 898-25. Accordingly, framework details 898-15, virtual details 898-41, and compute details 898-48 depend upon web servers 898-11.

Computer and Network Operating Environment

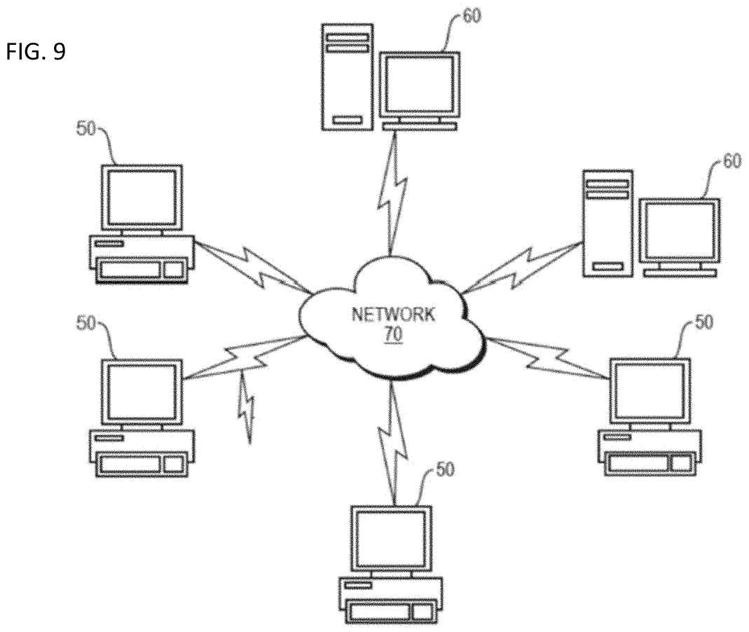

FIG. 9 illustrates a computer network or similar digital processing environment in which embodiments of the present disclosure may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

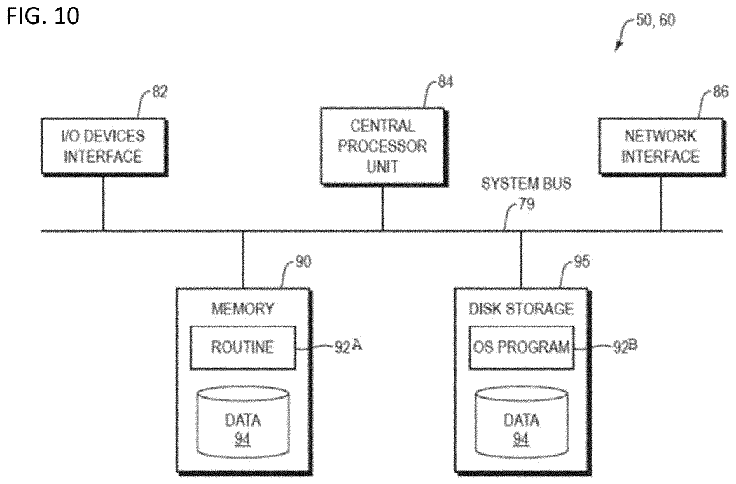

FIG. 10 is a diagram of an example internal structure of a computer (e.g., client processor/device 50 or server computers 60) in the computer system of FIG. 9. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 9). Memory 90 provides volatile storage for computer software instructions 92 (shown in FIG. 10 as computer software instructions 92A and 92B) and data 94 used to implement an embodiment of the present disclosure. Disk storage 95 provides non-volatile storage for computer software instructions 92 and data 94 used to implement an embodiment of the present disclosure. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for an embodiment. The computer program product 92 can be installed by any suitable software installation procedure, as is well known in the art. In another embodiment, at least a portion of the software instructions may also be downloaded over a cable communication and/or wireless connection. In other embodiments, the processor routines 92 and data 94 are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present processor routines/program 92 and data 94.

Embodiments or aspects thereof may be implemented in the form of hardware including but not limited to hardware circuitry, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of automatically determining configuration information pertaining to a computing workload, the method comprising:
at a machine learning engine:
interfacing with a workload deployed upon a network to determine file structures of the workload;
comparing the determined file structures of the workload with pre-defined representations of file structures stored in a classification database; and
identifying configuration information pertaining to the workload based on the comparing.

2. The method of claim 1 wherein the workload includes at least one of a framework, an operating system, and a software application.

3. The method of claim 1 wherein the workload includes hardware, elements of the hardware including at least one of: one or more processors, one or more memory devices, one or more storage devices, and one or more network adapters, the method further comprising:
determining a status of a resource pertaining to the hardware by taking a pre-defined number of measurement samples at a node of the hardware, and comparing a function of the measurement samples with a pre-defined threshold value.

4. The method of claim 1 wherein the configuration information is at least one of an identifier of a framework or library associated with the workload and at least one of a language, a version, and a name of a framework, operating system, or application deployed upon the workload.

5. The method of claim 1 wherein the configuration information includes type details of a virtualization environment deployed upon the workload, wherein the type details include at least one of a designation as serverless, a designation as a container, and a designation as a virtual machine.

6. The method of claim 1 further comprising:
configuring the machine learning engine to modify representations of file structures stored within, or store additional representations of file structures within, the classification database according to an update of a framework, operating system, or application, or creation of a new framework, operating system, or application.

7. The method of claim 1 wherein the identifying includes evaluating a result of the comparing with an accuracy threshold.

8. The method of claim 1 further comprising:
automatically determining a protection action based on the identified configuration information, and
issuing an indication of a recommendation of the determined protection action to a controller associated with the workload.

9. The method of claim 8 further comprising:
automatically selecting the recommendation from a recommendation database.

10. The method of claim 8 wherein the recommendation is selected from a recommendation database by an end-user.

11. The method of claim 8 further comprising, prior to issuing the indication of the recommendation, augmenting a recommendation database in response to an input from an end-user defining the recommendation.

12. The method of claim 1 further comprising:
deploying software instrumentation upon the workload, the software instrumentation configured to determine real-time performance characteristics of the workload.

13. The method of claim 12 wherein the software instrumentation is further configured to indicate a condition of overload perceived at the workload.

14. The method of claim 1 wherein the identified configuration information includes an indication of a vulnerability associated with the workload, wherein the vulnerability is identified based on an examination of process memory, the indication of the vulnerability further providing a quantification of security risk computed based on the examination of process memory.

15. The method of claim 1 wherein the identified configuration information includes an indication of at least one file that is to be touched by a given process during a lifetime of the given process running upon the workload, the method further comprising:
constraining execution of the given process to prevent the given process from loading files other than the at least one file that is to be touched by the given process, thereby increasing trust in the given process.

16. The method of claim 1 wherein the workload includes a plurality of workloads.

17. The method of claim 16 wherein a framework, an operating system, or an application is distributed or duplicated amongst the plurality of workloads.

18. The method of claim 16 further comprising constructing a topological representation of the plurality of workloads based on identified configuration information corresponding to respective workloads of the plurality thereof.

19. A system for automatically determining configuration information pertaining to a computing workload, the system comprising a machine learning engine configured to:
interface with a workload deployed upon a network to determine file structures of the workload;
compare the determined file structures of the workload with pre-defined representations of file structures stored in a classification database; and
identify configuration information pertaining to the workload based on the comparing.

20. A computer program product for automatically determining configuration information pertaining to a computing workload, the computer program product comprising:
one or more non-transitory computer-readable storage devices and program instructions stored on at least one of the one or more storage devices, the program instructions, when loaded and executed by a processor, cause a machine learning engine associated with the processor to:
interface with a workload deployed upon a network to determine file structures of the workload;
compare the determined file structures of the workload with pre-defined representations of file structures stored in a classification database; and
identify configuration information pertaining to the workload based on the comparing.
